(19) United States
(12) Patent Application Publication
(10) Pub. No.: US 2015/0146714 A1
(43) Pub. Date: May 28, 2015

(54) MULTI-HOP WIRELESS COMMUNICATION METHOD USING MANAGEMENT DEVICE AND WIRELESS DEVICES FOR SYNCHRONIZING WIRELESS DEVICES IN THE CONNECTIONLESS MULTI-HOP WIRELESS NETWORKS

(71) Applicant: Electronics and Telecommunications Research Institute, Daejeon (KR)

(72) Inventor: BONG SOO KIM, Daejeon (KR)

(21) Appl. No.: 14/555,445

(22) Filed: Nov. 26, 2014

(30) Foreign Application Priority Data
Nov. 27, 2013 (KR) 10-2013-0145658

(51) Int. Cl. H04W 56/00

(52) U.S. Cl. CPC H04W 56/001; H04W 84/18
USPC 370/350

(57) ABSTRACT

A multi-hop wireless communication method using a management device and wireless devices for synchronizing wireless devices in a connectionless multi-hop wireless network. The multi-hop wireless communication method using a management device includes: setting a sequence pattern at a fixed management device in a connectionless multi-hop wireless network; generating a message packet that comprises at least the set sequence pattern; and transmitting the generated message packet to mobile wireless devices.

### CROSS-REFERENCE TO RELATED APPLICATION(S)

This application claims priority from Korean Patent Application No. 10-2013-0145658, filed on Nov. 27, 2013, in the Korean Intellectual Property Office, the entire disclosure of which is incorporated herein by reference for all purposes.

### BACKGROUND

1. Field

The following description relates to a technology of wireless transmission and radio is waves, and more particularly, to a multi-hop communication technology in connectionless wireless networks.

2. Description of the Related Art

Containers in a space as large and limited as an open-air storage yard at a port may be controlled wirelessly by integrating the space as one wireless network. For efficient management, mobile wireless devices may be installed in containers, and types, presence, and management status of containers may be managed through wireless communications between a fixed management device and containers. In this case, a management device uses substantially high output radio waves so that the radio waves can reach wireless networks, and the management device may receive a response packet from the wireless devices that receive the radio waves. Alternatively, relay devices for intermediate transmission of radio waves may be installed, so that the radio waves may reach a wireless network, and the management device may receive a response packet. The methods mentioned above require strong radio waves, or installation of relay devices, thereby increasing equipment costs.

In order to prevent such cost inefficiency, a mobile wireless device may be configured to receive a message packet and to retransmit the received message packet. In this manner, as a wireless device receives a message packet transmitted from a management device, and retransmits the received message packet, the output of radio waves used may be low without any need for intermediate relay devices. In a case where mobile wireless devices, such as containers including wireless devices, may frequently enter and leave an open-air storage yard integrated as a wireless network, there may be containers that newly enter the yard, and may not respond to a response request packet transmitted from a management device due to inconsistent internal state of a wireless device for receiving a packet transmitted from a management device, is or due to a wireless device not knowing an address of a management device, and failing to report.

### SUMMARY

According to an exemplary embodiment, there is provided a multi-hop wireless communication method using a management device and wireless devices for synchronizing wireless devices in the connectionless multi-hop wireless networks, which enables all wireless devices to receive packets transmitted from a management device in the connectionless multi-hop wireless networks, and enables wireless devices newly entering the wireless networks to transmit response packets to the management device.

In one general aspect, there is provided a multi-hop wireless communication method using a management device, the method includes: setting a sequence pattern at a fixed management device in a connectionless multi-hop wireless network; generating a message packet that includes at least the set sequence pattern; and transmitting the generated message packet to mobile wireless devices.

In another general aspect, there is provided a multi-hop wireless communication method using a wireless device, the method includes: receiving a message packet at a mobile wireless device in a connectionless multi-hop wireless network; extracting at least a sequence pattern from the received message packet; and determining a method for processing the received message packet by analyzing the extracted sequence pattern.

### BRIEF DESCRIPTION OF THE DRAWINGS

FIG. 1 is a diagram illustrating an example of transmitting a message packet from a management device to other wireless devices in a wireless network through multi-hop is communication of a broadcast or a multicast communication.

FIG. 2 is a block diagram illustrating an example of a management device and a wireless device according to an exemplary embodiment.

FIG. 3 is a flowchart illustrating an example of transmitting a message packet from a management device to a wireless device according to an exemplary embodiment.

FIG. 4 is a flowchart illustrating an example method of receiving a message packet at a wireless device according to an exemplary embodiment.

FIGS. 5 to 8 are detailed flowcharts illustrating an example of determining a method for processing the received packet in FIG. 4 according to various exemplary embodiments.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION

The following description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

First, terms to be used throughout the present disclosure are defined as follows:
Management device: a device that manages presence, management status, etc. of all wireless devices in a wireless network of a certain area.
Wireless device: devices that are operated wirelessly, and present in a wireless network of a certain area, and examples thereof include a wireless sensor node, and an active radio frequency identification (RFID) device.
Wireless network: a wireless communication region, which is as large and limited as an open-air storage yard.
Session: a period from a point where processors recognize each other via message exchange for performing communication to the end of the communication.
Broadcast communication: a communication method of transmitting identical information to a plurality of devices at the same time.
Multicast communication: a communication method of transmitting identical information to devices of an identical group at the same time.
Unicast communication: a communication method of transmitting identical information to devices of a predetermined address.
Looping phenomenon: a repetitive phenomenon where a transmitter transmits one message, and a receiver that receives the message sends the same message back to the transmitter.
RFID (Radio-Frequency Identification): a technology used for identifying information from a distance using radio waves.
Active RFID: RFID that uses tag power for reading information in a chip and for communicating the information.
Specific sequence pattern: a pattern that is located in a system area of a message packet, and is composed of n-bits that are changed at every transmission, such that the pattern is distinguishable.

Hereinafter, the present disclosure will be described based on the terms described above.

A management device checks a wide wireless network of a specific area, in which wireless devices are included, for the presence and management statuses of these wireless devices. The management device uses a session-based broadcast or multi-cast communication to transmit a message packet to wireless devices that are present beyond the reach of its radio waves. In the course of the wireless communications, wireless devices serve as relay devices to transmit a packet by the same communication method as a method used to receive the packet from a management device. Further, each wireless device transmits the received message packet back to other wireless devices using a broadcast communication or a multi-cast communication, and analyzes the received message packet content to perform processing according to the analysis. In a session-based communication method, a session is open for a period of time predetermined at an initial session setting stage, and a packet may be received only during that time period. After the period has lapsed, the session is closed, and other wireless devices transmit a message packet, but a management device may not receive the packet.

The management device performs the following multi-hop routing to other wireless devices in an identical wireless network using a session-based broadcast or a multi-cast communication.

1. The management device forms a message packet with its address and desired content, and sets an open session period. Then, the management device transmits the message packet io using a broadcast or a multi-cast communication, without an address of a specific wireless device in the message packet. When transmitting the message packet, the management device uses a wireless communication module to output the message packet as radio frequency (RF) data. After a predetermined period, the session is closed, and the management device may not receive any message packets. Thus, wireless devices are required to respond to the message packet is during the open session period.

2. The management device and adjacent wireless devices receive a message packet output as RF data from the management device by using a wireless communication receiving module, and analyze content of the received message to perform operations requested in the received message. Further, a message packet is created to be identical to the received message packet, and the formed message packet is transmitted again by the same communication method as a method used to receive the message packet.

3. The above process 2 may be repeated.

4. Through the above processes2 and 3, the message packet is transmitted to all wireless devices in an identical wireless network, and the packet is processed.

5. As wireless devices in a wireless network go through the above processes 2 and 3, these wireless devices may receive the same message packet several times, which is called looping. In order to prevent the looping phenomenon, according to an exemplary embodiment, a management device is formed with n-bits in a system area instead of a user area in a message packet to be transmitted, such that a specific sequence pattern, which changes at every transmission, is included in the message packet to be transmitted to wireless devices.

6. Wireless devices in a wireless network receive a message packet, extract a sequence pattern from the received message packet, and then determine whether the extracted sequence pattern is identical to a sequence pattern extracted from a previous message packet and recorded io by the wireless devices. If the sequence pattern is identical, which means that this message packet is identical to a previously received message packet, wireless devices discard the message packet without processing.

During this process, a new wireless device may enter a wireless network from the outside, or a wireless device currently present in a wireless network may go outside. In this case, the is following problem 1 may occur.

1. A management device may not be aware of a sequence pattern of a wireless device, which newly enters a wireless network from the outside. If a wireless device newly entering a wireless network from the outside has a sequence pattern that is identical to a sequence pattern to be newly transmitted by the management device, the wireless device discards a message packet received from the management device. This problem should be prevented.

As wireless devices in a wireless network communicate wirelessly with each other, there may be a case where wireless devices cannot receive a message packet transmitted by a management device due to various environmental changes and constraints. In this case, the following problem 2 may occur.

2. Wireless devices, which did not receive a message packet from a management device due to various environmental changes and constraints, cause inconsistency in sequence patterns, which has an influence on receiving future message packets from a management device.

If a wireless device newly enters a wireless network from the outside as described above in 1, the following problem 3 may occur.

3. As a wireless device newly entering a wireless network from the outside receives a message packet from a management device through several stages via a relay wireless device, such that the wireless device may not know an address of a management device to which a response to the received message packet is to be sent. Accordingly, there is a need to provide a management device address for a wireless device newly entering a wireless network, so that the wireless device may send a response message packet to that address.

Hereinafter, the present disclosure will be described in detail with reference to the accompanying drawings in order to solve the above problems 1, 2, and 3.

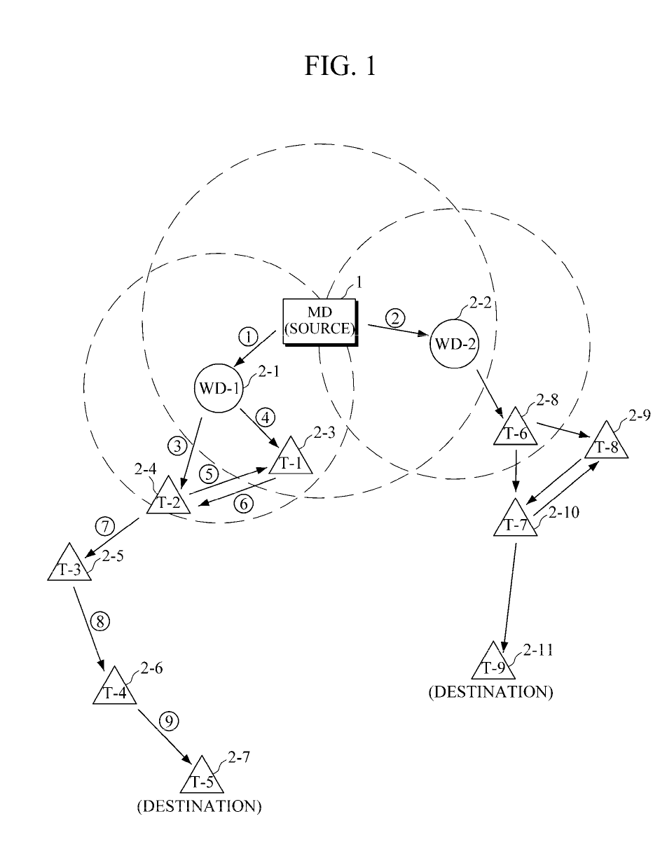

FIG. 1 is a diagram illustrating an example of transmitting a message packet from a is management device (MD) 1 to other wireless devices (WD-n, Tag: T-n) 2-1 to 2-11 in a wireless network via multi-hop communication of a broadcast or a multicast type.

Specifically, FIG. 1 illustrates wireless communication paths from the management device 1 to other destination wireless devices 2-1, 2-2, 2-3, 2-4, 2-5, 2-6, 2-7, 2-8, 2-9, 2-10, 2-11 in a wireless network using a broadcast or multi-cast communication. It is possible to have tier 1 communications from the management device 1 to wireless devices WD-1 2-1, WD-2 2-2, and T-1 2-3, which are present within a wireless output range of the management device 1. However, wireless devices T-2 2-4, T-3 2-5, T-4 2-6, T-5 2-7, T-6 2-8, T-7 2-9, T-8 2-10, and T-9 2-11, which are beyond a wireless output range of the management device 1, receive a message packet from the management device 1 by a multi-hop method, in which wireless devices WD-1 2-1, WD-2 2-2, and T-1 2-3, which received the message packet from the management device 1, retransmit the received message packet by the same communication method as a method used to receive the message packet. In this manner, a wireless device T-5 2-7, which is farthest from the management device 1, may receive a message packet via a multi-hop communication of a broadcast or a multi-cast communication method.

Further, wireless devices T-1 2-3 and T-2 2-4, which receive the same message packet from wireless device WD-1 2-1 by a broadcast or a multi-cast communication method, retransmit the message packet by a broadcast or a multi-cast communication method. As a result, the same message packet is transmitted from wireless device T-1 2-3 to wireless device T-2 2-4, and from T-2 2-4 to T-1 2-3 repeatedly, resulting in looping.

In order to prevent the looping, the management device 1 forms a message packet, with a sequence pattern of n-bits, which changes at every transmission, included in a system area of the message packet. In this case, when wireless device T-1 2-3 transmits a message packet to wireless device T-2 2-4, the T-2 2-4, which has already received the message packet from is wireless device WD-1 2-1, extracted a sequence pattern from the received message packet, and stored the extracted sequence pattern, extracts a sequence pattern from a message packet received from the T-1 2-3, and compares the extracted sequence pattern to a previous sequence pattern. In this case, as the currently received sequence pattern is identical to a previously received sequence pattern, the T-2 2-4 discards the message packet without retransmitting it via a broadcast or a multi-cast communication. In the same manner, wireless device T-1 2-3 also discards the message packet received from the T-2 2-4, thereby preventing looping.

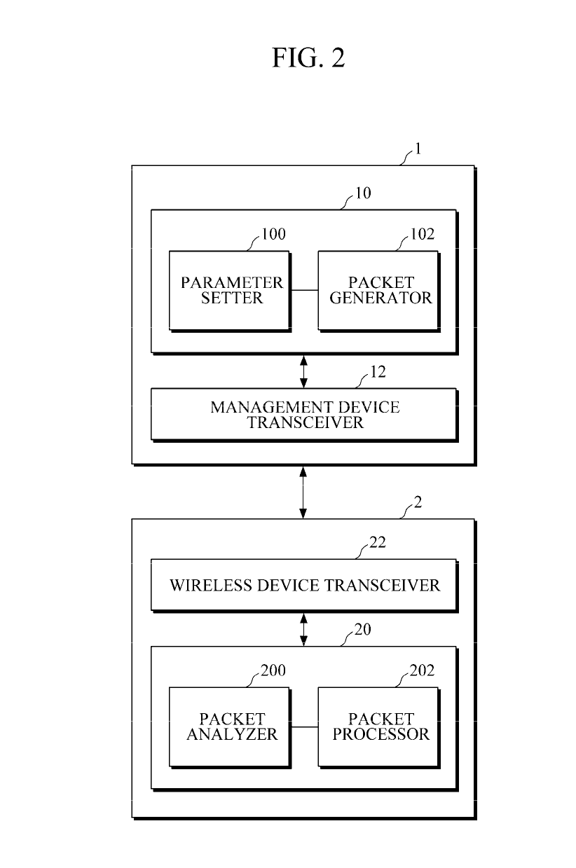

FIG. 2 is a block diagram illustrating an example of a management device and a wireless device according to an exemplary embodiment.

Referring to FIG. 2, the management device 1 includes a synchronizer 10 and a management device transceiver 12, in which the synchronizer 10 includes a parameter setter 100 and a packet generator 102. The wireless device 2 includes a synchronization processor 20 and a wireless device transceiver 22, in which the synchronization processor 20 includes a packet analyzer 200 and a packet processor 202.

The parameter setter 100 of the management device 1 sets a sequence pattern to generate a message packet. The sequence pattern changes every time the management device 1 generates a message packet. Further, when a message packet is retransmitted by the wireless device 2 in a wireless network using a multi-hop communication method, the parameter setter 100 sets a maximum multi-hop count for performing maximum multi-hop communications. Further, the parameter setter 100 sets an open session period, during which a session is open in the management device 1. In addition, the parameter setter 100 may also set a broadcast, or a multi-cast communication method. The packet generator 102 generates a message packet into which various parameters set in the parameter setter 100 are inserted. The management device is transceiver 12 transmits and receives a message packet, in which a message packet generated in the packet generator 102 may be transmitted to the wireless device 2. The management device transceiver 12 may transmit a message packet to the wireless device 2 using a communication method set by the parameter setter 100.

The packet analyzer 200 of the wireless device 2 receives a message packet from the management device 1, and analyzes the received message packet, in which the packet analyzer 200 may extract a sequence pattern from the received message packet, and determine a method for processing the received message packet based on the extracted sequence pattern.

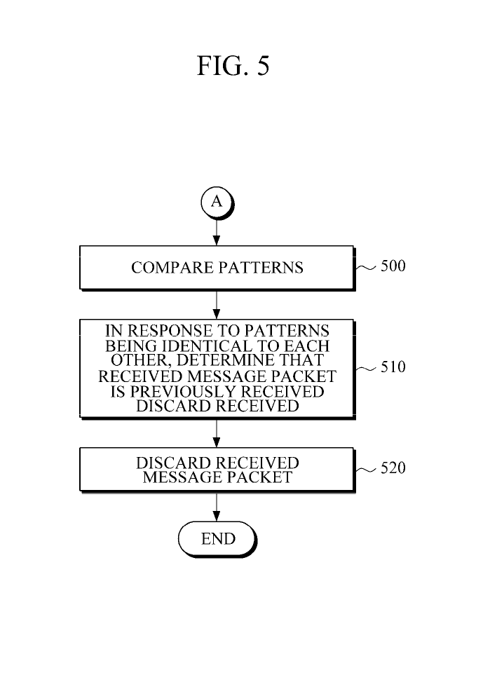

According to an exemplary embodiment, a processing method to be determined by the packet analyzer 200 varies depending on i) whether a current sequence pattern extracted from a currently received message packet is identical to a previous sequence pattern extracted from a previously received message packet; ii) whether a sequence pattern is a synchronization sequence pattern; and iii) whether a sequence pattern is a sequence pattern for notifying an address of a management device. Exemplary embodiments thereof will be described in detail with reference to FIGS. 5 to 8 below. The packet processor 202 processes a received message packet according to a processing method determined by the packet analyzer 200.

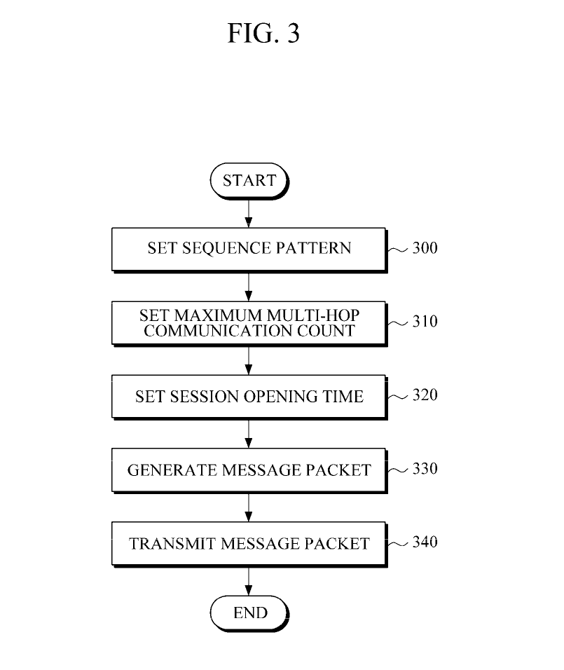

FIG. 3 is a flowchart illustrating an example process of transmitting a message packet from a management device to a wireless device according to an exemplary embodiment.

Referring to FIG. 3, a management device sets a sequence pattern to generate a message packet in operation 300. The sequence pattern changes every time the management device generates a message packet.

Subsequently, when a message packet is retransmitted by a wireless device in a wireless network via multi-hop communications, the management device sets a maximum multi-hop count for performing maximum multi-hop communications in operation 310. A maximum is multi-hop count is reduced by 1 at every passage of one wireless device, and when the count reaches 0, a message packet will no longer be retransmitted.

Further, an open session period is set in operation 320, during which a session is open in a management device. After this period has lapsed, the session is closed, and any packet sent thereafter from all wireless devices to a management device is not received by the management device. A message packet is generated in operation 330 using parameters prepared in operations 300 to 320 described above. Then, the generated message packet is transmitted to a wireless device in operation 340.

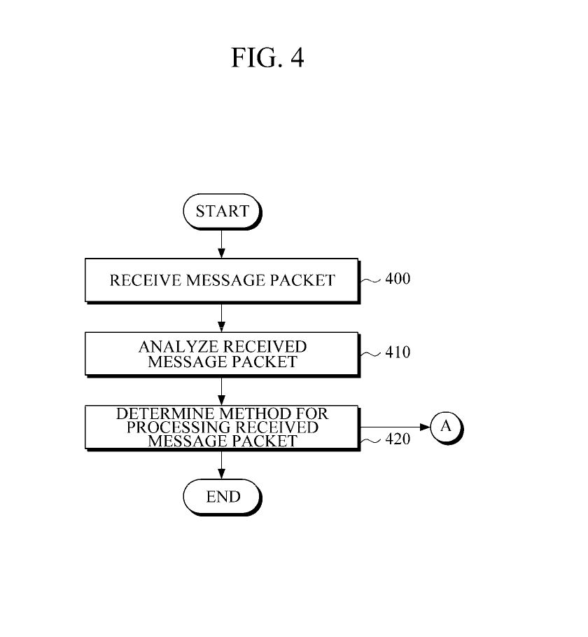

FIG. 4 is a flowchart illustrating an example method of receiving a message packet at a wireless device according to an exemplary embodiment.

Referring to FIG. 4, a wireless device in a wireless network receives a message packet in operation 400. Subsequently, the wireless device analyzes the received message packet in operation 410, and a sequence pattern may be extracted from the received message packet during the analysis. Then, parameters, such as a maximum multi-hop count and a communication method, may be further extracted. Thereafter, the wireless device determines a method for processing the received message packet according to the extracted sequence pattern in operation 420.

FIGS. 5 to 8 are detailed flowcharts illustrating an example of determining the method for processing the received packet in FIG. 4 according to various exemplary embodiments.

Referring to FIG. 5, in the wireless device according to an exemplary embodiment, a sequence pattern extracted from a currently received message packet is compared to a previous sequence pattern recorded and stored by the wireless device in operation 500. Upon comparison of the current and previous sequence patterns, in response to the patterns being identical to each other, the wireless device determines in operation 510 that the received message is packet is a message packet previously received, and discards the currently received message packet in operation 520.

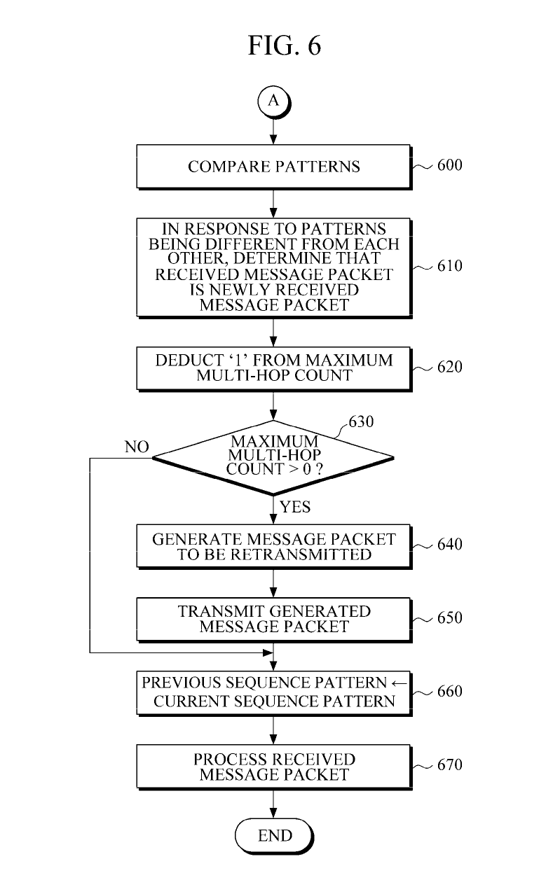

Referring to FIG. 6, in the wireless device according to an exemplary embodiment, a sequence pattern extracted from a currently received message packet is compared to a previous sequence pattern recorded and stored by the wireless devices in operation 600. Upon comparison of the current and previous sequence patterns, in response to the patterns being different from each other, the wireless device determines in operation 610 that the currently received message packet is a message packet newly transmitted from a management device.

Subsequently, the wireless device extracts a maximum multi-hop count from a currently received message packet, and deducts 1 from the extracted maximum multi-hop count in operation 620. Then, it is determined in operation 630 whether the maximum multi-hop count, from which 1 is deducted, is greater than 0. In response to the maximum multi-hop count being greater than 0, the wireless device generates a message packet to be retransmitted in operation 640, and transmits the generated message packet to other mobile wireless devices in a wireless network in operation 650. In this case, a message packet may be generated to be identical to a received message packet, and the generated message packet may be retransmitted to other mobile wireless devices by the same communication method as a method used to receive a message packet. Then, the wireless device stores a currently extracted sequence pattern as a previous sequence pattern in operation 660, and processes a currently received message packet in operation 670.

By contrast, in operation 630 for determining whether the maximum multi-hop count, from which 1 is deducted, is greater than 0, in response to a determination that the maximum multi-hop count is not greater than 0, a currently extracted sequence pattern is stored as a previous sequence pattern in operation 660 without retransmitting the message packet, and is processes a currently received message packet in operation 670.

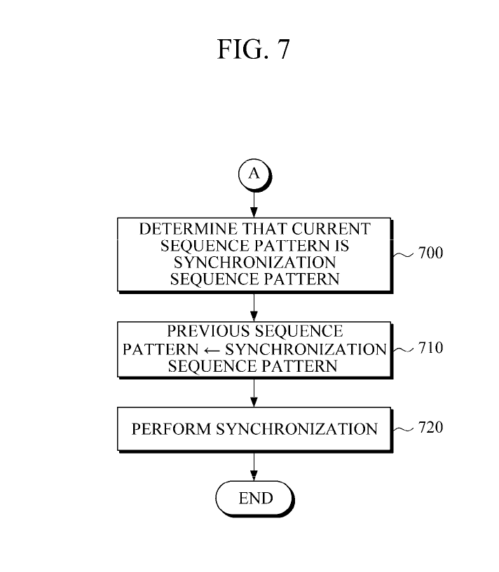

Referring to FIG. 7, according to an exemplary embodiment, a wireless device analyzes a sequence pattern extracted from a currently received message packet. In response to an analysis that the sequence pattern is a synchronization sequence pattern, it is determined in operation 700 that the sequence pattern is a synchronization message packet for synchronization between a management device and a wireless device. Then, the extracted synchronization sequence pattern is stored as a previous sequence pattern in operation 710, and synchronization is performed in operation 720.

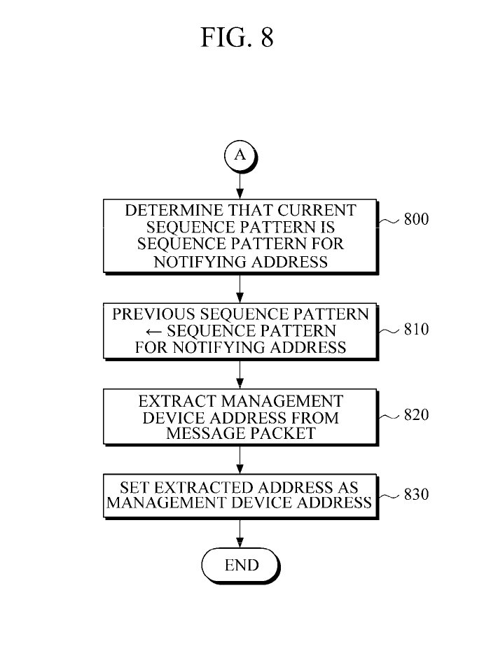

Referring to FIG. 8, according to an exemplary embodiment, a wireless device analyzes a sequence pattern extracted from a currently received message packet. In response to an analysis that the sequence pattern is a pattern for notifying a management device address, it is determined in operation 800 that the sequence pattern is a packet for notifying a fixed management device address to a mobile wireless device newly entering a wireless network, so that the wireless device may transmit a response packet to the address. Then, an extracted sequence pattern for notifying a management device address is stored as a previous sequence pattern in operation 810, a management device address is extracted from a currently received message packet in operation 820, and the extracted management device address is set in operation 830 as a management device address to which a response packet is to be transmitted.

As described above, 1) when a wireless device newly enters a wireless network from the outside, the wireless device is synchronized by a management device through a specific sequence pattern in a message packet so that the message packet may be received from the management device.

2) In order to resolve any inconsistencies in sequence patterns of wireless devices that fail to receive a message packet from a management device due to various environmental changes is and constraints, a wireless device is synchronized by a management device through a specific sequence pattern in a message packet so that the message packet may be received from the management device.

3) In order to solve a problem of a wireless device newly entering a wireless network from the outside not being able to transmit a response message due to the wireless device not knowing a management device address to which to send a response message, the management device notifies a management device address through a specific sequence pattern, so that the wireless device newly entering the wireless network may transmit a response message packet to the management device.

When a wireless device newly enters a wireless network, a problem may occur in that a sequence pattern of the new wireless device is not known, such that a message packet transmitted from a management device with an identical sequence pattern may be discarded, since the message packet may be considered to be identical to a message packet previously received by wireless devices. However, according to an exemplary embodiment, such problem may be prevented. In other words, a management device transmits a specific sequence pattern to wireless devices to synchronize the wireless devices, thereby enabling a wireless device newly entering the wireless network to receive future message packets that will be transmitted from the management device.

According to another exemplary embodiment, wireless communications between wireless devices in a wireless network may prevent cases in which message packets transmitted from a management device are not received due to various environmental changes and other constraints.

According to still another exemplary embodiment, a problem, which occurs when a is wireless device newly enters a wireless network, and a response packet may not be transmitted due to the wireless device not knowing the address of a management device that requests the response packet, may be prevented. In other words, as a management device transmits, to wireless devices, a message packet that includes a specific sequence pattern indicating an address of the management device, the wireless device may report a response packet to a management device address indicated by the specific sequence pattern. As a result, the wireless devices may know to which management device a response packet is to be sent, and thus, management efficiency of wireless communications may be enhanced.

A number of examples have been described above. Nevertheless, it should be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims. Further, the above-described examples are for illustrative explanation of the present invention, and thus, the present invention is not limited thereto.

What is claimed is:

1. A multi-hop wireless communication method using a management device, the method comprising:
setting a sequence pattern at a fixed management device in a connectionless multi-hop wireless network;
generating a message packet that comprises at least the set sequence pattern; and
transmitting the generated message packet to mobile wireless devices.

2. The method of claim 1, wherein the sequence pattern is located in a system area of the message packet, and changes every time the message packet is generated.

3. The method of claim 1, further comprising setting a maximum multi-hop count for maximum multi-hop communications when the message packet is retransmitted through is multi-hop communications by the wireless devices in the wireless network,
wherein the generating of the message packet comprises generating a message packet that comprises at least the set sequence pattern and the maximum multi-hop count.

4. The method of claim 1, further comprising:
setting an open session period; and
closing the session after the set open session period has lapsed, and blocking any packets transmitted thereafter from the wireless devices to the management device,
wherein the generating of the message packet comprises generating a message packet that comprises at least the set sequence pattern and the open session period.

5. The method of claim 1, further comprising determining a communication method,
wherein the transmitting to the wireless devices comprises transmitting the generated message packet to the wireless devices by the determined communication method.

6. The method of claim 5, wherein the determined communication method is any one of a broadcast method or a multi-cast method.

7. The method of claim 1, wherein the transmitting to the wireless devices comprises transmitting, to the wireless devices, the generated message packet with an address of the management device included therein.

8. A multi-hop wireless communication method using a wireless device, the is method comprising:
receiving a message packet at a mobile wireless device in a connectionless multi-hop wireless network;
extracting at least a sequence pattern from the received message packet; and
determining a method for processing the received message packet by analyzing the extracted sequence pattern.

9. The method of claim 8, wherein the receiving of the message packet comprises receiving a message packet from a fixed management device or other mobile wireless device.

10. The method of claim 8, wherein the determining of the method for processing the received message packet comprises:
comparing a current sequence pattern extracted from a currently received message packet to a previous sequence pattern extracted from a previously received message packet; and
in response to a comparison result that the current and the previous sequence patterns are identical, determining that the currently received message packet is a message packet that was previously received, and discarding the currently received message packet.

11. The method of claim 8, wherein the determining of the method for processing the received message packet comprises:
comparing a current sequence pattern extracted from a currently received message packet to a previous sequence pattern extracted from a previously received message packet; and
in response to a comparison result that the current and the previous sequence patterns are different, determining that the currently received message packet is a message packet newly is transmitted from a management device, and processing the currently received message packet.

12. The method of claim 11, wherein the processing of the currently received message packet comprises:
extracting a maximum multi-hop count from the currently received message packet, and deducting 1 from the extracted maximum multi-hop count;
in response to the maximum multi-hop count, from which 1 is deducted, being greater than 0, generating a message packet to be retransmitted, and transmitting the generated message packet to other wireless device in a wireless network;
storing the currently extracted sequence pattern as a previous sequence pattern; and
processing the currently received message packet.

13. The method of claim 12, wherein the transmitting to the other wireless device in the wireless network comprises:
generating a message packet to be identical to the received message packet; and
transmitting the generated message packet to the other wireless device by a same method as a communication method used to receive the message packet.

14. The method of claim 12, wherein the processing of the currently received message packet further comprises:
in response to the maximum multi-hop count, from which 1 is deducted, not being greater than 0, storing the currently extracted sequence pattern as a previous sequence pattern without retransmitting the message packet; and
processing the currently received message packet.

15. The method of claim 8, wherein the determining of the method for processing the received message packet comprises:
in response to a sequence pattern extracted from the currently received message packet being a synchronization sequence pattern, determining that the sequence pattern is a synchronization message packet transmitted for synchronization between the management device and the wireless device; and
storing the extracted synchronization sequence pattern as a previous sequence pattern.

16. The method of claim 15, wherein:
the wireless device is a wireless device newly entering a wireless network from an outside; and
the multi-hop wireless communication method further comprises synchronizing through a synchronization message packet received from the management device, so as to enable the wireless device newly entering the wireless network to receive a message packet from the management device.

17. The method of claim 15, wherein:
the wireless device is a wireless device that has failed to receive a message packet from the management device due to environmental changes and constraints in a wireless network; and
the multi-hop wireless communication method further comprises synchronizing through a synchronization message packet received from the management device, so as to enable the wireless device, which has failed to receive a message packet from the management device, to receive a message packet from the management device.

18. The method of claim 8, wherein the determining of the method for processing the received message packet comprises:
in response to a sequence pattern extracted from the currently received message packet being a sequence pattern for notifying an address of the management device, determining that the sequence pattern is a packet for notifying the management device address to a wireless device newly entering the wireless network, so as to enable the wireless network to transmit a response packet to the address;
storing the extracted sequence pattern for notifying the management device address as a previous sequence pattern;
extracting the management device address from the currently received message packet; and
setting the extracted management device address as an address of the management device to which a response packet is to be transmitted.

19. The method of claim 18, wherein:
the wireless device is a wireless device that newly enters a wireless network from an outside; and
the multi-hop wireless communication method further comprises transmitting, at the to wireless device newly entering the wireless network, a response message packet to the management device address by using the sequence pattern for notifying the management device address received from the management device.
